(19) United States
(12) Patent Application Publication
(10) Pub. No.: US 2012/0272764 A1
(43) Pub. Date: Nov. 1, 2012

(54) MODULAR PUMP DESIGN

(76) Inventor: Gary Pendleton, Spring, TX (US)

(21) Appl. No.: 13/342,657

(22) Filed: Jan. 3, 2012

Related U.S. Application Data
(60) Provisional application No. 61/480,242, filed on Apr. 28, 2011.

(51) Int. Cl. F16H 1/06; F16H 1/04; F16H 1/16; B23P 15/00

(52) U.S. Cl. 74/414; 29/888.02; 74/412 R; 74/425

(57) ABSTRACT

Modular pumps comprising universal gearboxes and crank units and associated methods.

### CROSS-REFERENCE TO RELATED APPLICATIONS

This application claims the benefit of U.S. Provisional Patent Application Ser. No. 61/480,242, filed on Apr. 28, 2011, the entire disclosure of which is hereby incorporated by reference.

### BACKGROUND

Reciprocating pumps are used extensively throughout the oil and gas industry. These types of pumps are commonly used as mud pumps and fracturing pumps. These pumps are capable of delivering fluids and other various media to the application process at various flow rates and pressures.

Reciprocating pumps come in a variety of sizes and configurations. For example, reciprocating pumps may be configured in triplex, quadruplex, and quintuplex configurations. The power output of the pumps can range from 300 horsepower to in excess of 2500 horsepower. The specific configuration of the pumps is often designed to suit the particular application requirements.

Reciprocating pumps are typically manufactured to order and, as a result, may take several months to manufacture and deliver. Reciprocating pumps are generally constructed with left-hand or right-hand drive mechanisms with the casing being specific to each application. This impacts the type of drive which can be employed in the pump. For example, worm drive pumps have their driveline at 90 degrees to the axial crank orientation and pinion drive pumps and planetary gears installations have their drivelines parallel to the axial crank orientation. Consequently, pumps are generally constructed to a specification, specific for the application, making the construction process severely restricted by configuration requirements.

There is a need for an improved process of manufacturing reciprocating pumps.

### SUMMARY

The present invention relates to a modular pump design. More particularly, the present invention relates to a modular pump design comprising universal components and associated methods.

In one embodiment, the present invention provides a modular pump comprising a universal gearbox and a crank unit, wherein the crank unit is attached to the universal gearbox.

In another embodiment, the present invention provides a universal gearbox for use in a reciprocating pump.

In another embodiment, the present invention provides a method of assembling a reciprocating pump comprising: providing a universal gearbox; providing one or more crank units; and attaching the one or more crank units to the universal gearbox.

The features and advantages of the present invention will be readily apparent to those skilled in the art. While numerous changes may be made by those skilled in the art, such changes are within the spirit of the invention.

### BRIEF DESCRIPTION OF THE DRAWINGS

A more complete and thorough understanding of the present embodiments and advantages thereof may be acquired by referring to the following description taken in conjunction with the accompanying drawings.

FIGS. 1 and 2 are illustrations of universal gearboxes in accordance with certain embodiments of the present disclosure.

FIGS. 3 and 4 are illustrations of crank units in accordance with certain embodiments of the present disclosure.

FIGS. 5 and 6 are illustrations of how reciprocating pumps in accordance with certain embodiments of the present disclosure may be assembled.

FIGS. 7-14 are illustrations of reciprocating pumps in accordance with certain embodiments of the present disclosure.

### DETAILED DESCRIPTION

The present invention relates to a modular pump design. More particularly, the present invention relates to a modular pump design comprising universal components and associated methods.

There may be several potential advantages of the modular pumps and methods disclosed herein. One of the many potential advantages of the modular pumps and methods disclosed herein is that they may allow for a streamlined pump construction process. Another potential advantage of the modular pumps and methods disclosed herein is that they may provide a pump design which is adaptable to client requirements without the need for significant customization. Another potential advantage of the modular pumps and methods disclosed herein is that they may provide for multiple final pump constructions that can be achieved with fewer parts and assemblies without relying upon a specific component manufacture. Another potential advantage of the modular pumps and method disclosed herein is that the may provide a pump design that is easier to maintain. It is feasible that a universal component of the modular pump design discussed herein could be sent to a jobsite for the replacement of a damaged unit, for example, a crank unit could replaced completely with a new replacement unit at the jobsite by suitably qualified personal.

By separating the main elements of the pump into discrete assemblies, such as gearboxes and crank units, it is possible to formalize the construction approach. By providing gearboxes and crank units which are “universal,” the construction approach to pump assembly can be improved. As used herein, the term “universal” is used to refer to components that are not specific to a left or right hand configuration, but rather can function in right handed, left handed, and no handed configurations. By utilizing the methods discussed herein, universal pump components can be built for inventory and then simply be bolted together to meet the configuration demands of a client, reducing the lead time for delivery from months to possibly days. A main consideration of this approach is to understand how the gearboxes and the crank units can be assembled to create a specific pump configuration. The following information is a concept to achieve a streamlined pump construction process.

In certain embodiments, the present disclosure provides a modular pump comprising a gearbox and a crank unit. The modular pumps discussed herein may have any range of horsepower. In certain embodiments, the pumps discussed herein may be 500, 1000, 1500, 2000, or 2500 horsepower pumps.

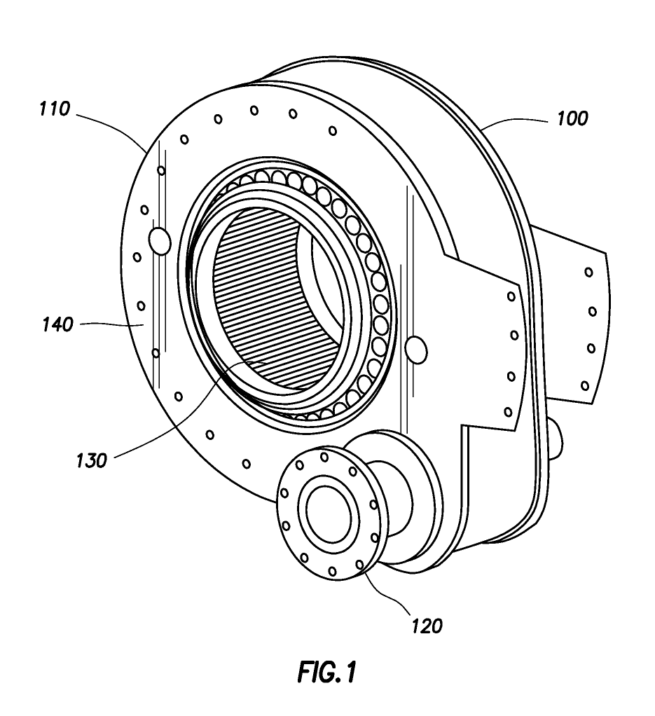

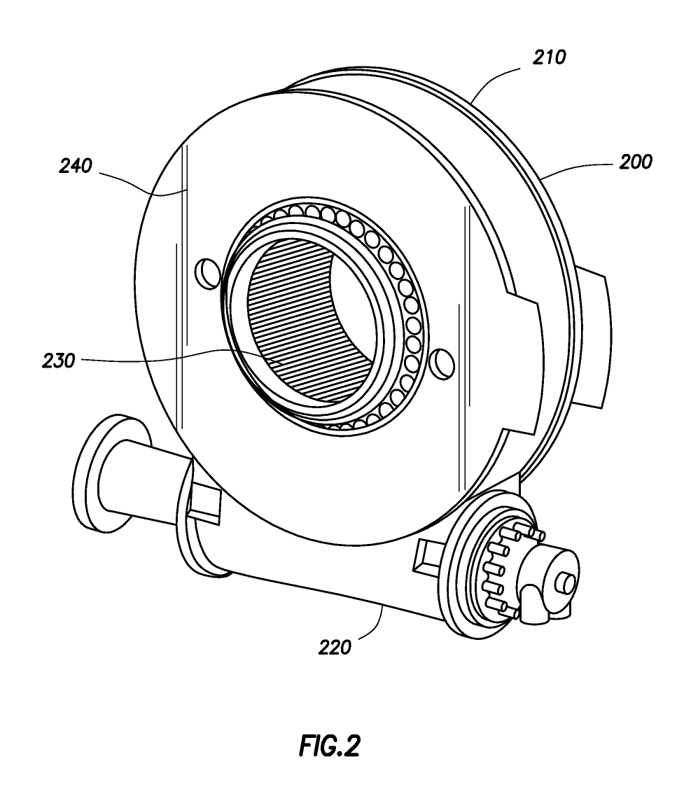

In certain embodiments, the gearbox may be a universal gearbox. Examples of gearboxes include worm/wheel gear drives, pinion drives, and planetary drive gear systems. An example of a pinion drive gear box is illustrated in FIG. 1. An example of a worm gear drive box is illustrated in FIG. 2.

Referring now to FIG. 1, FIG. 1 illustrates a pinion drive gear box 100. In certain embodiments, pinion drive gear box 100 may comprise a housing 110, an opposed helical gear 120, a universal adapter hub 130, and one or more mounting surfaces 140. Each of the components of pinion drive gear box 100 may be constructed out of any suitable material to withstand pressures of up to 20,000 psi and temperatures up to 400° F. In some embodiments, the components of pinion drive gear box 100 may be constructed out of AISI 4140 steel, AISI 4330 steel, or derivatives thereof.

In certain embodiments, the opposed helical gear 120 may be a herringbone gear. In certain embodiments, the universal adapter hub 130 comprises a splined internal detail. In certain embodiments, the universal adapter hub 130 may be suitable for both pinion and worm drives. In certain embodiments, opposed helical gear 120 may be mechanically connected to universal adapter hub 130 such that when rotational energy is applied to helical gear 120, that rotational energy is transmitted to universal adapter hub 130 which then rotates inside the pinion drive gear box 100. Once rotating, universal adapter hub 130 may then provide drive to one or more crank units through its splined internal detail.

Referring now to FIG. 2, FIG. 2 illustrates a worm drive gear box 200. In certain embodiments, worm drive gear box 200 may comprise a housing 210, a worm style gear 220, a universal adapter hub 230, and one or more mounting surfaces 240. Each of the components of worm drive gear box 200 may be constructed out of any suitable material to withstand pressures of up to 20,000 psi and temperatures up to 400° F. In some embodiments, the components of worm drive gear box 200 may be constructed out of AISI 4140 steel, AISI 4330 steel, or derivatives thereof.

In certain embodiments, the universal adapter hub 230 comprises a splined internal detail. In certain embodiments, the universal adapter hub 230 may be suitable for both pinion and worm drives. In certain embodiments, worm style gear 220 may be mechanically connected to universal adapter hub 230 such that when rotational energy is applied to worm style gear 220, that rotational energy is transmitted to universal adapter hub 230 which then rotates inside the worm drive gear box 200. Once rotating, universal adapter hub 230 may then provide drive to one or more crank units through its splined internal detail.

The gearboxes discussed in the present disclosure may be universal in that one or more crank units may be attached to either side of the gearboxes without any modification of the gearbox. In other embodiments, one crank unit may be attached to one side of the gear box and a cover may be attached to the other side of the gear box. Consideration has been made to the method attaching the crank units to the gearboxes. In certain embodiments, the connection may be made via a central splined hub unit to drive the cranks, with the main crank fabricated housing attaching directly to the gearbox housing. By maintaining the same width between a worm drive and a pinion drive, it is possible to maintain the same assembly methods for the crank units.

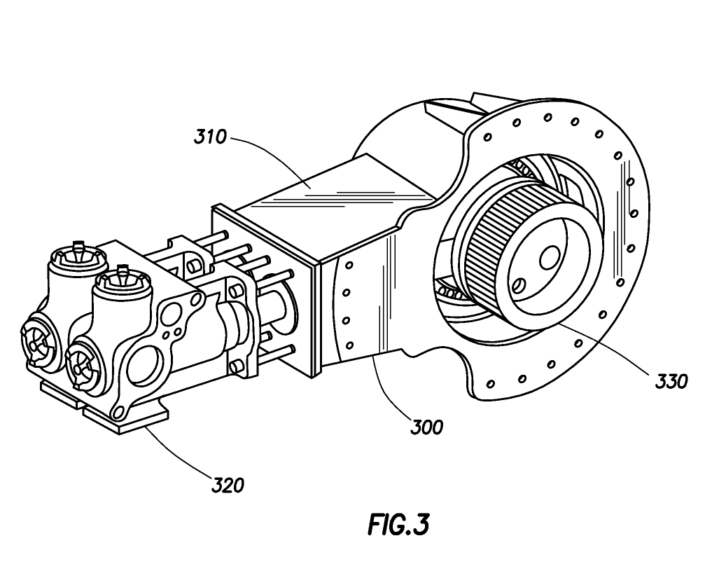

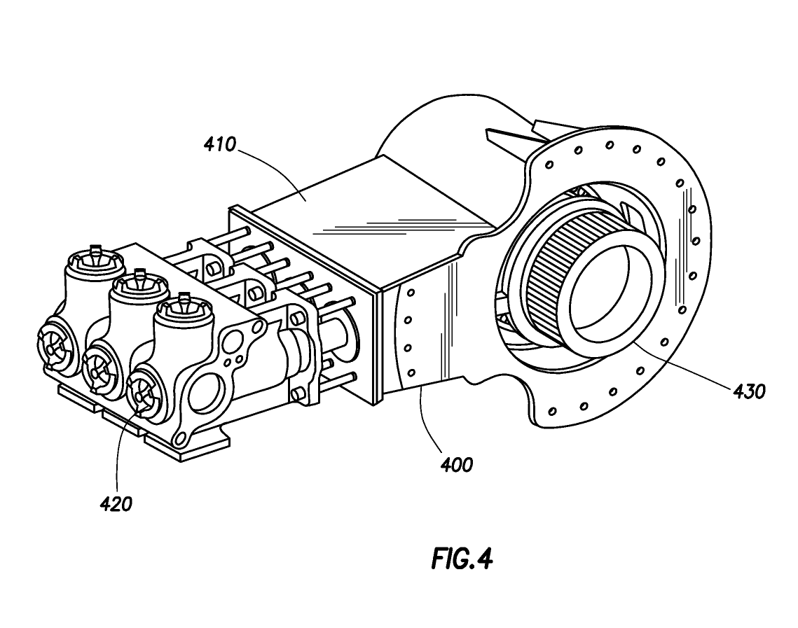

The crank unit may comprise any number of throws. In certain embodiments, the crank unit may be a three throw crank (triplex) or a five throw crank (quintuplex). In the case of the quintuplex, the arrangement may be a two+three throw crank arrangement with each crank being on either side of the gearbox. An example of a two throw crank unit is illustrated in FIG. 3. An example of a three throw crank unit is illustrated in FIG. 4.

Referring now to FIG. 3, FIG. 3 illustrates a two throw crank unit 300. The two throw crank unit 300 may comprise a housing body 310, fluid ends 320, and a central splined hub unit 330. Referring now to FIG. 4, FIG. 4 illustrates a three throw crank unit 400. The three throw crank unit 400 may comprise a housing body 410, fluid ends 420, and a central splined hub unit 430. Each of the components of two throw crank unit 300 and three throw crank unit 400 may be constructed out of any suitable material to withstand pressures of up to 20,000 psi and temperatures up to 400° F. In some embodiments, the components of two throw crank unit 300 and three throw crank unit 400 may be constructed out of AISI 4140 steel, AISI 4330 steel, or derivatives thereof.

Regardless of the number of throws, each crank unit may be made up of a housing and locating bearings (not illustrated), to which the crank may be assembled. The crank itself can have varying throw distance. In some embodiments, the throw distance may range from 6 to 12 inches. Each crank throw may be attached to a connecting rod/piston arrangement which is ultimately used in the pumping process via the fluid end units.

In certain embodiments, for example in a triplex configuration, the radial throw separation may be 120 degrees. In other embodiments, for example in a quintuplex configuration, the radial throw separation may be 72 degrees. However, in either case, the essence of the crank manufacture may be the same. By manufacturing 2 (72 or 120 degree) crank units, it is possible to utilize the same housing bearing construction elements. Making the housing a universal arrangement may result in a universal pump (albeit the pump can be configured as a left or right hand drive).

In the case of the Triplex pump, the crank unit may be simply bolted to the gearbox either on the left or the right side of the gearbox. Similarly the a quintuplex pump can be configured as left or right configuration with the 2 throw crank mounted to the opposite side of the gearbox relative to the 3 throw crank. Internal features to the crank ensure absolute crank timing.

Taking the ability to customize the construction also results in further opportunities to refine the customization. For example a quadruplex pump could be constructed using 2+2 throw crank units (the cranks being manufactured for 90 degree separation). Possibly more extreme would be a Hexaplex Pump utilizing a 3+3 configuration, subject to drive, flow rate and pressure requirements.

The separation of the gearbox also allows adaptability of the drive system to include planetary gear units (which may be limited to triplex configuration), or other means of propulsion, e.g. hydraulic motor. Consequently the customizability of the configurations is not limited to triplex or quintuplex configurations, but using the design principles multiple configurations are possible utilizing a few key elements.

In certain embodiments, the present disclosure provides a method of assembling a reciprocating pump comprising: providing a universal gearbox; providing one or more crank units; and attaching the one or more crank units to the universal gearbox. In certain embodiments, the one or more crank units may be attached to either side of the universal gearbox or both sides.

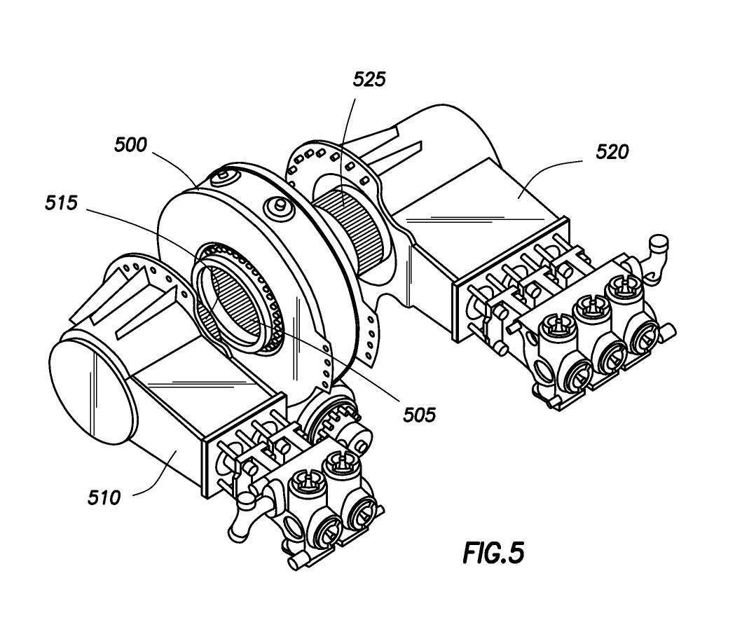

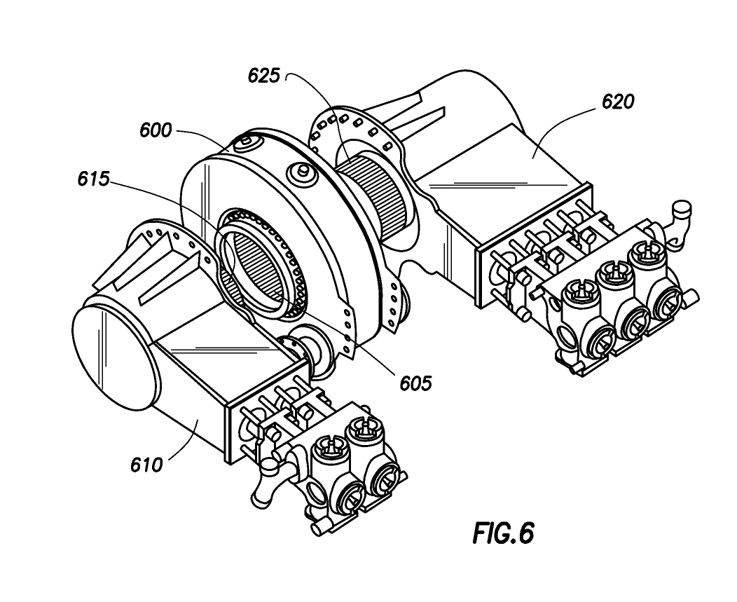

FIGS. 5 and 6 depict how in certain embodiments, the reciprocating pumps of the present disclosure may be assembled.

As illustrated in FIG. 5, two throw crank unit 510 may be slid into worm drive gear box 500 in a manner such that the central splined hub unit 515 of two throw crank unit 510 rests inside universal adapter hub 505 of worm drive gear box 500. Similarly, as also illustrated in FIG. 5, three throw crank unit 520 may be slid into worm drive gear box 500 in a manner such that the central splined hub unit 525 of three throw crank unit 520 rests inside universal adapter hub 505 of worm drive gear box 500. Once assembled in such a manner, two throw crank unit 510 and three throw crank unit 520 may then be bolted onto worm drive gear box 500.

As illustrated in FIG. 6, two throw crank unit 610 may be slid into pinion drive gear box 600 in a manner such that the central splined hub unit 615 of two throw crank unit 610 rests inside universal adapter hub 605 of pinion drive gear box 600. Similarly, as also illustrated in FIG. 6, three throw crank unit 620 may be slid into pinion drive gear box 600 in a manner such that the central splined hub unit 625 of three throw crank unit 620 rests inside universal adapter hub 605 of pinion drive gear box 600. Once assembled in such a manner, two throw crank unit 610 and three throw crank unit 620 may then be bolted onto pinion drive gear box 800.

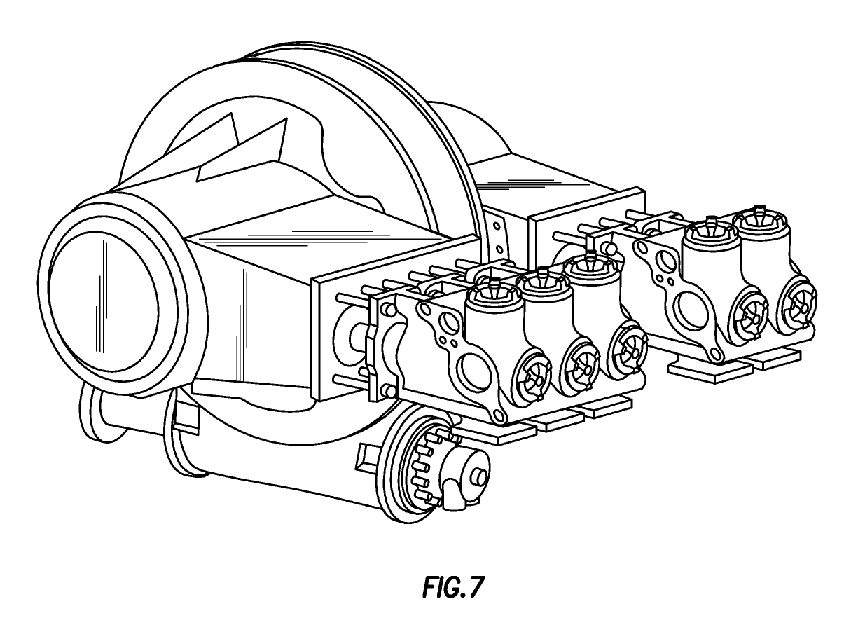

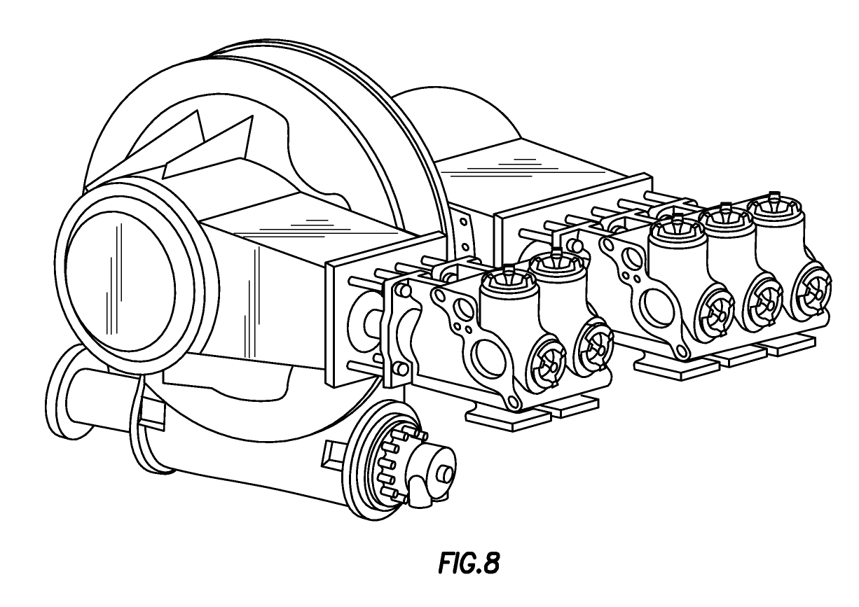

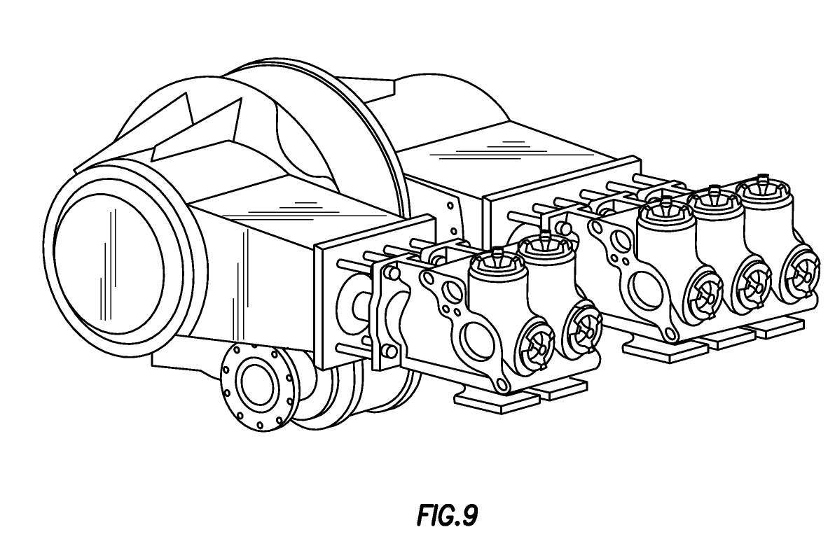

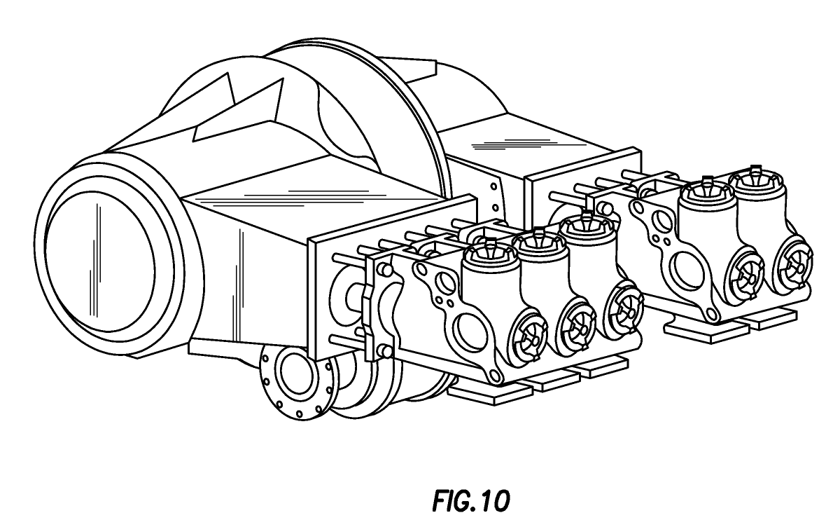

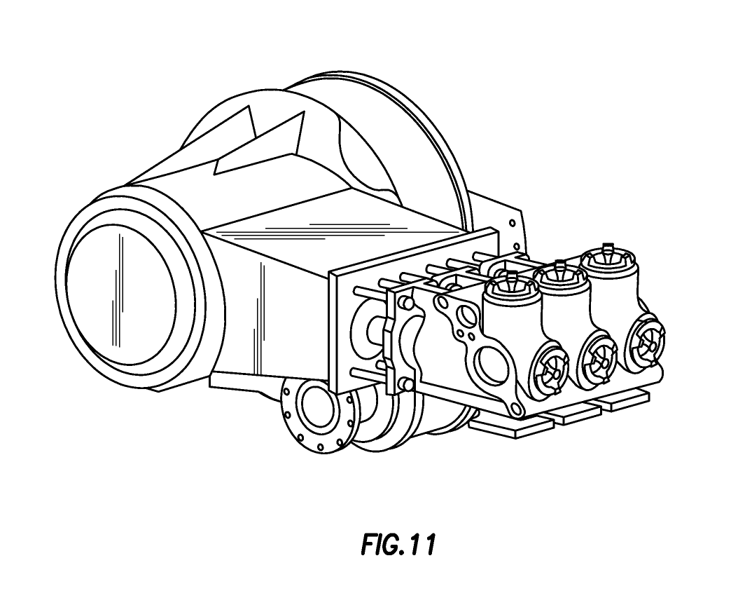

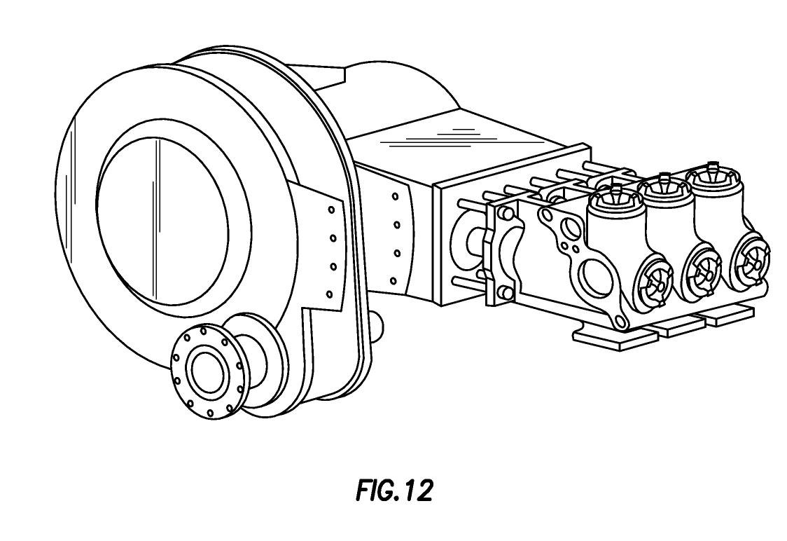

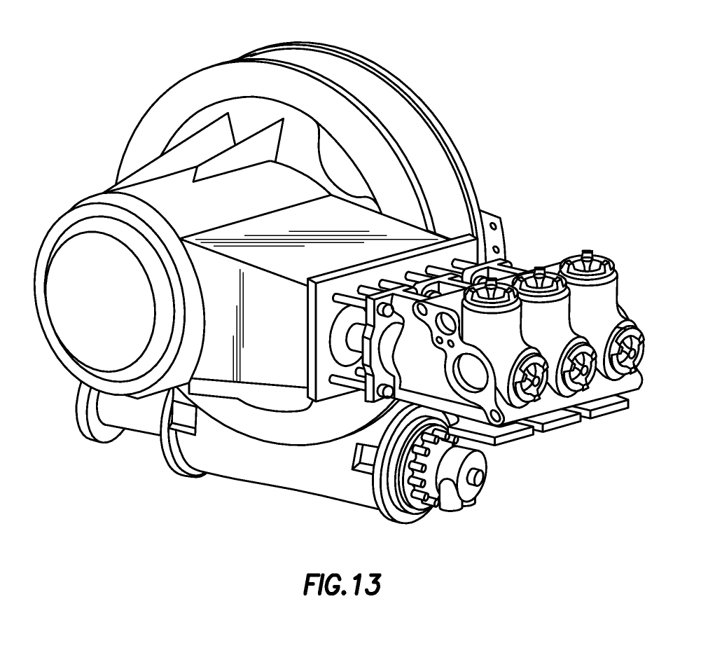

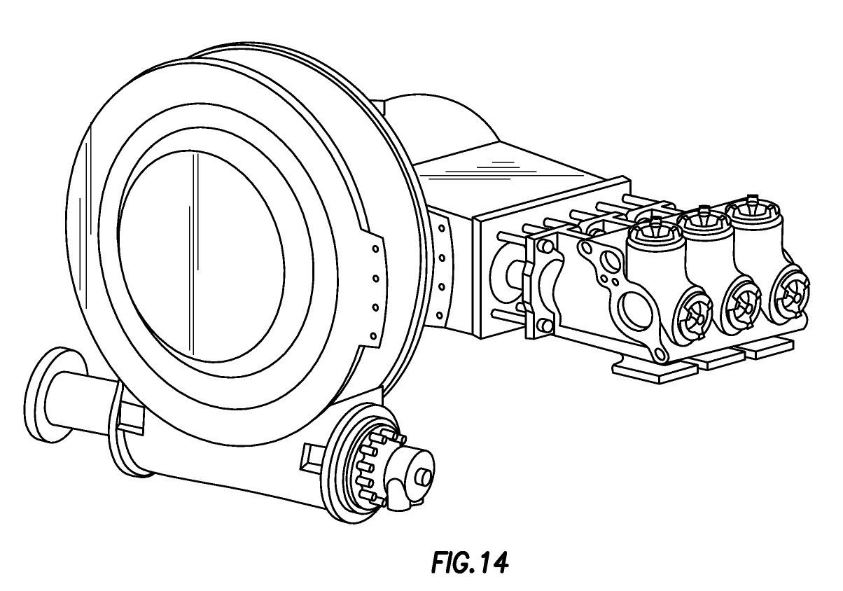

FIGS. 7-14 illustrate various possible configurations of gearboxes and crank units in accordance with certain embodiments of the present disclosure. FIGS. 7 and 8 illustrate quintuplex pump designs with worm drives in accordance to certain embodiments of the present disclosure. FIGS. 9 and 10 illustrate quintuplex pump designs with pinion drives in accordance to certain embodiments of the present disclosure. FIGS. 11 and 12 illustrate triplex pump designs with pinion drives in accordance to certain embodiments of the present disclosure. FIGS. 13 and 14 illustrate triplex pump designs with worm drives in accordance to certain embodiments of the present disclosure.

Although the present invention and its advantages have been described in detail, it should be understood that various changes, substitutions and alternations can be made herein without departing from the spirit and scope of the invention as defined by the following claims.

What is claimed is:

1. A modular pump comprising a universal gearbox and a first crank unit, wherein the first crank unit is attached to the universal gearbox.

2. The modular pump of claim 1, wherein the universal gear box comprises a worm drive gear box.

3. The modular pump of claim 1, wherein the universal gear box comprises a pinion drive gear box.

4. The modular pup of claim 1, wherein the modular pump comprises a second crank unit, wherein the second crank unit is attached to the universal gear box.

5. The modular pump of claim 1, wherein the first crank unit is a two-throw crank unit.

6. The modular pump of claim 1, wherein the first crank unit is a three-throw crank unit.

7. The modular pump of claim 1, wherein the first crank unit is a two-throw crank unit and the second crank unit is a three-throw crank unit.

8. The modular pump of claim 1, wherein the modular pump is a triplex pump.

9. The modular pump of claim 1, wherein the modular pump is a quadruplex pump.

10. The modular pump of claim 1, wherein the modular pump is a quintuplex pump.

11. A universal gearbox for use in a reciprocating pump.

12. The universal gearbox of claim 11, wherein the universal gearbox is a worm drive gear box.

13. The universal gearbox of claim 12, wherein the universal gearbox comprises a housing, a worm style gear, and universal adapter hub.

14. The universal gear box of claim 12, wherein a crank unit may be attached to a left side and a right side of the universal gearbox.

15. The universal gear box of claim 11, wherein the universal gearbox is a pinion drive gear box.

16. The universal gearbox of claim 15, wherein the universal gearbox comprises a housing, an opposed helical gear, and a universal adapter hub.

17. The universal gear box of claim 15, wherein a crank unit may be attached the a left side and a right side of the universal gearbox.

18. A method of assembling a reciprocating pump comprising: providing a universal gearbox; providing one or more crank units; and attaching the one or more crank units to the universal gearbox.

19. The method of claim 18, wherein the universal gearbox comprises a universal adapter hub.

20. The method of claim 19, wherein the assembly of the reciprocating pump occurs at a jobsite.
